(19) United States
(12) Patent Application Publication
(10) Pub. No.: US 2002/0132603 A1
(43) Pub. Date: Sep. 19, 2002

(54) Method for power save

(76) Inventors: Jan Lindskog, Pixbo (SE); Gunnar Rydnell, Ravlanda (SE); Per Grapatin, Goteborg (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/004,786

(22) Filed: Dec. 7, 2001

Related U.S. Application Data
(60) Provisional application No. 60/251,865, filed on Dec. 8, 2000.

(51) Int. Cl. H04B 1/16

(52) U.S. Cl. 455/343; 370/311; 340/7.32

(57) ABSTRACT

The invention refers to methods for power saving in a mobile terminal comprising a NIC, wireless Network Interface Card, used in a wireless LAN, WLAN or the like having at least one access point AP, said card either externally plugged in or built in or integrated in the PC, wherein the WLAN uses HIPERLAN Type 2 or IEEE 802.11 power save procedures and in which the mobile terminal uses an operating system supporting device power states, e.g. the OnNow device power states (D0-D3), in which method the mobile terminal requests a transition from an active state D0 to a less active state, upon which request the NIC requests the access point AP to be entered into WLAN sleep state, and on acknowledgement from the access point the mobile terminal enters WLAN sleep state.

The methods also concerns the behaviour of the NIC and the mobile terminal on in-activity and/or closing of the lid of a laptop being used in the above environment.

The invention concerns the field of Wireless LAN communication, and especially the relation between Wireless LAN pouter save concept interactions with PC power save for network devices, e.g. Wake-On-LAN.

The use of Wireless Network Interface Cards (NIC) is an increasing market segment. Products for the Wireless LAN standard such as IEEE 802.11b at 2.4 GHz exists, and products for the IEEE 802.11a and HiperLAN 2 at 5 GHz is expected to reach the market in the near future.

For the purpose of this description the following definitions are used: The devices described in this invention are the Personal Computer PC, tie wireless Network Interface Card NIC. The term Mobile Terminal refers to both the wireless Network Interface Card NIC and the PC. It should also be pointed out that D3 comprises two levels, i.e. D3 and D3 cold. From the state D3-cold as well as from a state called D0-initalise a wake-up is not possible.

The NIC may either be plugged in, e.g. PC Card, or built in or integrated into the PC. Examples of mobile terminals are Laptop, Palmtops, various kinds of handheld terminals, but also other wireless mobile terminals are known and still other types are expected to be introduced in the future.

In the office business segment the wireless NIC acts as a wireless cable replacement and when interconnected to a Local Area Network (CAN) the NIC and its Access Point (AP) can be seen as a wireless LAN. Host equipment are Laptop but also handheld devices such as Palmtop is likely for the future. With the use of IEEE 802.11 the host equipment station's can dynamically set up ad hoc network among several stations in the vicinity that enables wireless exchange within the ad hoc group.

With the HiperLAN 2 Home Environment profile host equipment station's can create a similar ad hoc network creating a wireless e.g. IEEE 1394 exchange.

The use of Wireless LAN systems, i.e. WLAN is thus expected to be frequently used both in office environment as well as in home environment. An example of such a WLAN is IEES802.11b that exists today that operates at 2.4 GHz. JEEE802.11b is capable of providing up to 11 Mbps. In the near future systems will be available that provides up to 54 Mbps that operates in the 5 GHz. Examples of such systems are IEEE 802.11a (802.11) and HIPERLAN Type 2 (H2).

Microsoft description on power save for network devices is called Wake-On-Lan which is the standard all devices in PCs running the Microsoft Windows family of operating system shall use. Wake-On-Lan is used to achieve low power consumption but still achieve connectivity for incoming information.

HIPERLAN Type 2 H2 power save procedures:

The power save concept of H2 is triggered by a mobile terminal request to enter sleep mode to the Access Point AP. The mobile terminal will request to join a specific sleep group, with a certain periodicity. Sixteen different sleep group exists, n=1..16, with their respective sleep periodicity as 2ⁿ frames.

A mobile terminal in H2 sleep mode will monitor the Broadcast Control Channel (BCCH) on a periodical basis, where the periodicity is determined by the sleep group. All mobile terminals within the same sleep group will monitor the BCCH simultaneous.

Upon such a monitoring, hereafter called H2 wake up occasion, the mobile terminal decodes the BCCH and determines whether a Data for Sleeping Terminal (DST) is set. The access point AP will set the DST if the frame consist of a wake up for at least one mobile terminal, or user multicast or broadcast data intended for sleeping mobile terminal as well as active mobile terminals. The type of user multicast or broadcast depends upon die type of fixed network connected to the access point AP, but typically it may be Ethernet multicast and Ethernet broadcast data.

Note that wake up in this context refers to the transition from sleep to active of the H2-part (or 802.11-part) of the mobile terminal, i.e. the parts necessary for WLAN operation may be located in both devices.

To accomplish a reasonable effort for the access point AP to distribute multicast and broadcast data to all mobile terminals upon all different sixteen sleep groups, the access point AP has a possibility to modify the proposed sleep group from a mobile. The access point AP will choose one out of the sixteen as its designated group to send multicast and broadcast data in. For mobile terminals requesting a sleep group with a periodicity higher that its designated sleep group, the access point AP will set the mobile terminal sleep group equal to its designated sleep group. Mobile terminals requesting shorter or equal, than the designated sleep group proposal will be unchanged.

To accomplish that all Mobile terminals within a sleep group has the correct wake up occasion, since the request to sleep are ‘asynchronous’ to the sleep group, the access point AP uses an offset of 0-(2ⁿ−1) frames to align the mobile terminals.

Upon a exemplary wake up occasion, the mobile terminal decodes the BCCH. If the DST indication is inactive, the Mobile terminal will revert to sleep.

If the DST indication is active, the mobile terminal will perform the following operations:

Decode the Frame Control Channel (FCCH) for the presence of a matching Medium Access Control-ID (MAC-ID) with the mobile terminal own MAC-ID The mobile terminal will then revert to active mode, i.e. at the occurrence of a matching MAC-ID the mobile terminal will revert to active mode.

Decode the FCH for the presence of multicast or broadcast within the frame, and if so receive the data.

Decode the following BCCH and execute the same set of rules again.

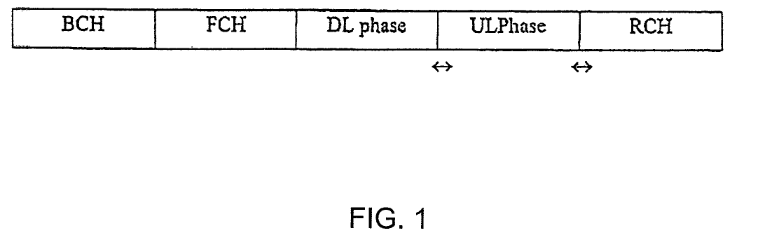

The BCCH is sent in th Broadcast Channel (BCH). The FCCH is sent in the Frame Channel (FCH). A typical frame is seen in FIG. 1

| | | | | | | |
|---|---|---|---|---|---|---|
| BCH | FCH | DL phase | | ULPhase | | RCH |
| | | | [symbol] | | [symbol] | |

DL phase/UL phase, UL phase/RCH border may be changed due to traffic requirement.

The standard IEEE 802.11 allows mobile terminals, in either an independent Basic Service Set (BSS) (the term ad hoc network is often used as slang for an independent BSS) or an infrastructure BSS, to enter low power modes of operation where they turn off their receiver and transmitter to conserve power.

In an ad hoc network a mobile terminal can change its power management state from being active to sleep after successfully completing a frame exchange sequence with the “Power Management Field” set to “1” (or sleep) sent to any other mobile terminal in the ad hoc network.

In an infrastructure BSS a mobile terminal can change its power management state from being active to sleep, after successfully completing a frame exchange sequence with the “Power Management Field” set to “1” (or sleep) sent to the AP.

For a detailed description of the power save procedures, and exact definition for the independent BSS and infrastructure BSS see IEEE 802.11 standard.

Wake-On-Lan Procedure

The Microsoft power save implementation uses the terms D0, D1, D2 and D3 which describes different power modes in a device, e.g. a mobile terminal where D0 is no power save at all and D3 is the deepest power save mode. The terms S0, S1, S2, S3, S4 and S5 describes the system power save mode where S0 is fully on and S4 is called hibernate mode which is a very deep sleep mode but is still able to resume without a reboot. In S5 the system is off and a reboot is the only way to resume the system again. The system in this context is the mobile terminal.

Prior to entering a low power mode D1, D2 or D3 an interrogation is executed between the devices, and the least capable mode for any of the devices on the bus is selected as the preferred mode (for the bus). Specific requirement, e.g. power consumption, exists upon each respective mode. The higher the number of the Dx (1,2 or 3) mode—the lower shall the power consumption be.

Wake-On-Lan can work from any Dx mode as long as the system mode is less than S5 and the device is able to follow the power consumption requirement for that Dx mode and still be able to detected received frames. When a device detects a wake-up event it signals that to the system (this is done in different ways depending on which bus the device is placed on, in CardBus the CSTSCHG# line is used for this). Note: It is possible that the system might be in S0 but the wireless Network Interface Card NIC device is in D1-D3. E.g. the user might force a disconnection towards the H2 or the 802.11 system. Then upon a Wake-On-Lan wake-up in this situation the mobile terminal behaves the same as in the normal case when the device goes to D0 and the system stays in S0.

Thus, prior to entering a low powermode D1, D2 or D3 an interrogation is executed between the devices, and the least capable mode for any of the devices on the bus is selected as the preferred mode (for the bus). Specific requirement, e.g. power consumption, exists upon each respective mode. The higher the number of the Dx (1,2 or 3) mode—the lower the power consumption will be.

Note: It is possible that the system might be in S0 but the NIC device is in D1-D3. E.g. the user might force a disconnection towards the H2 or 802.11 system. Then upon a Wake-On_LAN wake-up in this situation the mobile terminal behaves the same as in the normal case when the device goes to D0 and the system stays in S0.

For a detailed description of the Wake-On-Lan procedure see Network Device Class Power Management, Reference Specification.

### PROBLEM

When operating on batteries, the laptop PC's power consumption is important to keep low. It is obvious that the use of a wireless NIC will further decrease the battery life-time. That is a fact and it also is expected by the end user.

However, the end user will most likely not accept a significant decreased battery life-time even though the exact decrease is not possible to say and may vary from one user to another.

The interactions between the PC Power save mode or other WLAN NIC power saving mechanism , i.e. Wake-On-LAN and H2 or 802.11 power save is not known.

Even though the procedures for power save are different for the systems, both H2 and 802.11 have the same states “active” and “sleep” for the mobile terminal. The H2 and 802.11 systems are also equal in the sense that association and/or authentication of the mobile terminal are required in order to be active, e.g. be able to transmit/receive end user data.

Hereinafter sleep and active states for the mobile terminals in both systems are referred to when using the term WLAN sleep and WLAN active for a mobile terminal

Problem 1, 2, and 3 describes three examples where problems may occur. In the first example concern is taken to WLAN sleep when a proper power state is selected, whilst the other example does not.

Problem 1

If the wireless NIC is capable of D3 while in WLAN sleep state, and D1 while in WLAN active state, the outcome of the mode analysis, described above, might result in that the wireless NIC cain only allow down to D1, and subsequently no device can allow lower than D1. This will increase the power consumption for the mobile terminal if the power consumption for the devices are higher for D1 than it is for D3.

Problem 2

Assuming the PC to be in a low power mode system state, e.g. S3-S4, and the wireless NIC in WLAN sleep state and in D3.

Assume further that the mobile terminal at H2 or 802.11 wake up occasions receives data from the access point AP (or another mobile terminal in Km 802.11 ad hoc network) that changes the state of the mobile terminal from WLAN sleep to WLAN active.

Within WLAN active state the mobile terminal must monitor the wireless media that will increase the power consumption of the wireless NIC. That increase might cause the power consumption of the device to be higher than allowed for the D3 power state, thus causing a non compliance to the Wake-On-LAN requirement.

Problem 3

In order to decrease power consumption, the Laptop user frequently orders the PC to go into suspended mode by pressing a combination of keys (e.g. Alt F0) or by shutting down the case. For such conditions the power consumption of the wireless NIC may be relatively high compared to the total power consumption for the Laptop PC. Alternatively and worse, if the inability of the wireless NIC to enter a low power mode may prevent the Laptop PC to enter a low power mode, expected battery life time will become a problem.

Another very frequent condition is when the end user leaves the Laptop PC for other business, e.g. coffee break or meeting etc. For those occasions it is important to enter a low power mode to save battery life time. The similar problem may occur here that the wireless NIC may prevent the Laptop PC to enter a low power mode resulting in increased power consumption.

Solution

Active to Steep Transition

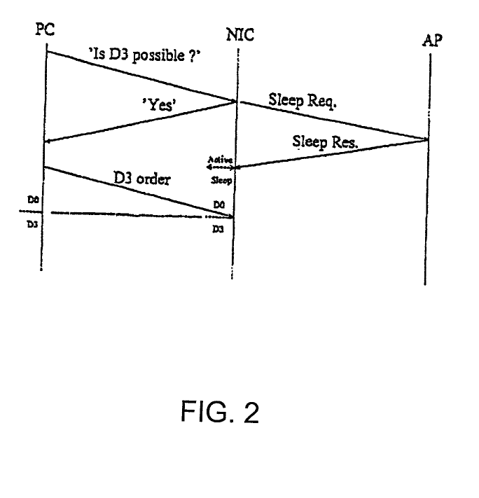

The proposed solution is to trigger a H2 sleep request (for H2) or setting the 802.11 ‘Power Management field’ to “sleep” and exchange a frame (for 802.11), denoted (1), upon an order to enter a transition from D0 to either of the states D1, D2 or D3. Example see FIG. 2 (H2 only).

Assuming the PC due to inactivity orders a transition from D0 to D3. Upon an order the H2 wireless NIC shall request the access point AP to enter H2 sleep state in order to minimise power consumption.

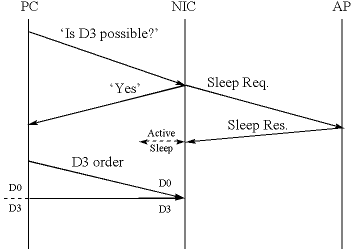

Once in WLAN sleep state, the wireless NIC is allowed to enter its low power consumption mode, thus allowing a deeper PC sleep state. Alternatively, the procedure above at (1) is executed prior to responding to the D0 to D1, D2 or D3 request (Is D3 possible?) See FIG. 2. As a third alternative the procedure above at (1) is executed after the D1, D2 or D3 order is received.

It will be appreciated by those skilled in the art that the PC may order another Dx mode than D3. This may be the result if another device on the bus is not capable of D3. It is also possible for the PC to inhibit the D1 D2 or D3 order. If in the example in FIG. 2 above D1 was ordered instead of D3, and the D1 mode for the NIC allows for the NIC to remain in WLAN active state, the NIC may request a state change from WLAN sleep to WLAN active towards the AP. However, the NIC may also remain in state WLAN sleep until a request to send pending data exists from the PC or until the AP changes the WLAN state of the mobile terminal.

It will also be appreciated by those skilled in the art that if the AP prevents the mobile station to enter WLAN sleep state, the NIC in ay refuse a transition to enter D1, D2 or D3 mode or execute procedures to wake up the PC if the NIC has entered D1, D2 or D3 mode prior to tie signaling above at (1), depending on whether the power requirement can be met in the D1, D2 or D3 mode despite the AP refusal to enter WLAN sleep.

Sleep to Active Transition

Upon an order from the PC to exit D1, D2 or D3 to the D0 state, the wireless NIC shall exit the WLAN sleep state, e.g. send a resource request message for H2 or exchange a frame filth ‘Power Management field’ set to active for 802.11.

Note: H2 sleep state is changed internally in the mobile when uplink data is pending at the wireless NMC. The access point AP state is changed by reception of any message indicating the corresponding MAC ID (medium access control) of a wireless NIC that is stored as being in sleep mode.

If no internal control message or data from the PC exist, then

a resource request message with zero uplink volume request can be sent from the mobile terminal for H2.

a null data frame can be sent from the mobile terminal for 802.11.

Alternatively, the wireless NIC changes its state from WLAN sleep to WLAN active, but does not start any actions and message exchanges in order to change the access point AP perception (or other mobile terminals perception only in an ad-hoc network for 802.11) of the mobile terminals sleep state until data transmission is requested.

Assuming the wireless NIC is in either of the state D1: D2 or D3, and wakeup has been requested prior to entering the D1, D2 or D3 state. (The alternatives below are given for an infrastructure access point AP with mobile terminals in WLAN sleep state, but they are also applicable for an ad-hoc network.)

Upon the situation where the access point changes the WLAN sleep state from sleep to active in order to signal control data, e.g. measurement requests, the NIC shall remain in its Dx state and immediately request for WLAN sleep after the proper actions due to the control signaling have been taken. Alternatively, if preferably the control signaling occurs seldom, the NIC shall proceed according to the procedures of waking up the PC thus changing the mode to D0. The latter may be needed if the available power in D1, D2 or D3 is insufficient for the required actions due to the control signaling. It will be appreciated by those skilled in the art that in order to retain the lower consumption that was held prior to the control signaling, the PC has to reinitiate the procedures to enter the lower power modes D1, D2 or D3.

Upon the situation where the access point AP changes the WLAN sleep state from sleep to active of the NIC in order to send unicast user data or broadcast or multicast user data or due to a detection of an access point AP link change, that does not fulfill the PC wake up condition, the wireless NIC shall immediately start the procedures at (1) above.

Upon the situation where the access point changes the WLAN sleep state from sleep to active of the NIC in order to send unicast user data or broadcast or multicast user data or due to a detection of an access point AP link change, that does fulfill the PC wake up condition, the wireless NIC shall proceed according to the procedures of waking up the PC, i.e. force a transition from D1, D2 or D3 to state D0.

Upon conditions where PC wake up is being detected by the wireless NIC, the wireless NIC shall proceed according the procedure of changing the D1, D2 or D3 to state D0, e.g. the AP does not cause the Dx state change. The wireless NIC shall also change its internal WLAN sleep state to active state as well as the access point AP state. The conditions might be due to that the Laptop end user requires to transmit data. (Alternatively, the wireless NIC changes its state from WLAN sleep to WLAN active but does not start any actions and message exchanges in order to change the AP perception (or other mobile terminals only in an ad-hoc network) of he mobile terminals sleep state until data transmission is requested.)

Assuming the PC and the wireless NIC is in either of the state D1, D2 or D3, and wakeup has not been requested prior to entering the D1, D2 or D3 state.

Irrespective or what causes the mobile terminal to change its state from WLAN sleep state to WLAN active state, the wireless NIC shall request for WLAN sleep state. Alternatively, if preferably the situation occurs seldom, the NIC shall proceed according to the procedures of waking up the PC thus changing the mode to D0. The latter may be needed if the available power in D1, D2 or D3 is insufficient. It will be appreciated by those skilled in the art that this may cause the power consumption of the PC to be high and should lead to that the PC shuts down, e.g. D3 Cold state, the NIC to prevent this from happening.

As a second embodiment to the wireless NIC behaviour above, the following proposal intends to further decrease the power consumption of the wireless NIC.

Within state D0, the wireless NIC is proposed to request for WLAN sleep state based on criteria such as user data inactivity. Assume a timer is started, or restarted, at every occurrence of unicast data flowing in either direction.

Assume further that the timer raises above a threshold. Upon that condition, the wireless NIC shall request for WLAN sleep.

Upon reception of user data from the PC, the wireless NIC shall revert to WLAN active state and restart the timer.

Upon the reception of a wake up from the access point AP, or in the case of an ad hoc network for 802.11, the wireless NIC shall restart the timer.

In a third embodiment of the behaviour described above the complexity of the wireless NIC is further decreased.

In this third embodiment the ability to wake tip the PC upon activities from the fixed network or change of the WLAN sleep state by the AP is ignored or not supported.

If one assumes that the wireless NIC is state D0 and the PC due to inactivity orders a transition from D0 to D3 (or D2 or D1). Upon the order the wireless NIC shall disassociate e.g. for 802.11 a Disassociation Notification, and/or deauthenticate, e.g. for 802.11 a DeAuthentication Notification, with the access point. This allows the wireless NIC to take all necessary actions to decrease its power consumption.

As one alternative the wireless NIC could ignore to transmit the disassociation signal.

Assume that the wireless NIC is in the state D3 (or D2 or D1) and the behaviour above in embodiment three has been performed, and the PC requests a transition to D0. Upon the request, the wireless NIC shall attempt to associate and/or authenticate with the previous access point.

In a fourth embodiment the user either closes the laptop case or it is proposed to automatically de-associate from the WLAN (H2 or 802.11) system.

This can either be done by simply powering off the wireless NIC card resulting in an automatic de-association or to signal de-association and stop monitoring the BCCH for H2 and Beacon for 802.11, and thus minimize power consumption. To automatically power off the device when closing the case also prevents radio transmission in an airplane or at similar places when radio transmission is prohibited.

It is also proposed to automatically associate and/or authenticate towards the WLAN when the end user opens the case. Since it is likely that the time to start up the PC compared to association and/or authentication towards the WLAN is low, the user will probably not notice the actions. Note that the for the existing IEEE 802.11 standard authentication is performed first followed by association whilst for H2 the association is performed first followed by authentication.

As a second embodiment it is proposed to monitor the activity in the PC, e.g. processing load, and based on an inactivity longer than a timeout, an application in the PC shall force the wireless NIC to go to a low power mode. One alternative is to power off the NIC. Another alternative, since it is likely that an application can not power off the NIC is to force the NIC to go into D0 initialized state with very low power consumption. Similar as above, the application shall also release the low power forcing of the NIC when activity is detected or when data is pending for transmission.

### MERITS OF THE INVENTION

The WLAN sleep and PC power save states interaction procedures provided above, will increase the probability of utilising a deeper sleep state in the PC, thus improving the battery lifetime of the PC.

Also for occasions such a when the end user closes the case of his or her Laptop PC, the power consumption of the wireless NIC will not contribute to a noticeable shortened battery life time.

For the occasion when the case is opened the automatic association of the NIC towards the WLAN, the end user will not be able to detect that the connection to the LAN had been lost.

For occasions when the case is left opened and application running on the Laptop PC. the inactivity based timeout implemented in an application running on the PC to force the NIC to enter Do initialised will result in low power consumption on the NIC while inactivity lasts.

1. Method for power saving in a mobile terminal comprising a NIC, wireless Network Interface Card, used in a wireless LAN, WLAN or the like having one access point AP, said card either externally plugged in or built in or integrated in the mobile terminal, wherein the WLAN uses HIPERLAN Type 2 or IEEE 802.11 power save procedures and in which the mobile terminal uses an operating system supporting device power states, e.g. the OnNow device power states (D0-D3), in which method:
the mobile terminal requests (I) a transition from an active state D0 to a less active state D3 (or D2 or D1),
upon which request the NIC requests the access point AP to be entered into WLAN sleep state,
on acknowledgement from the access point the mobile terminal enters WLAN sleep state.

2. Method according to claim 1 modified in that said request (I), is replaced by an order.

3. Method for power saving in a mobile terminal comprising a NIC, wireless Network Interface Card, used in a wireless LAN, WLAN or the like in an ad hoc network, said card either externally plugged in or built in or integrated in the mobile terminal, wherein the WLAN uses HIPERLAN Type 2 or IEEE 802.11 power save procedures and in which the mobile terminal uses an operating system supporting device power states, e.g. the OnNow device power states (D0-D3), in which method:
the mobile terminal requests (II) a transition from an active state D0 to a less active state D3 (or D2 or D1),
upon which request the NIC requests a further mobile terminal in the ad hoc network, i.e. the mobile terminal to be entered into WLAN sleep state, on acknowledgement from the further mobile terminal the mobile terminal enters WLAN sleep state

4. Method according to claim 3 modified in that said request, (II), is replaced by an order.

5. Method for power saving in a mobile terminal comprising a NIC, wireless Network Interface Card, used in a wireless LAN, WLAN or the like having one access point AP, said card either eternally plugged in or built in or integrated in the mobile terminal, wherein the WLAN uses HIPERLAN Type 2 or IEEE 802.11 power save procedures and in which the mobile terminal uses an operating system supporting device power states, e.g. the OnNow device power states (D0-D3), in which method:
the mobile terminal due to inactivity requests (IV) a transition from an active state D0 to a less active state D3 (or D2 or D1)
upon which request the NIC and/or mobile terminal requests the access point AP to be disassociated and/or de-authenticated from the access point,
on acknowledgement from the access point AP, the mobile terminal enters a disassociated and/or de-authenticated state.

6. Method according to claim 5 modified in that said request, (IV), is replaced by an order.

7. Method according to claim 1 in which the mobile terminal/NIC is disassociated and/or de-authenticated from the AP without using a disassociation and/or de-authentication signal.

8. Method for power saving in a mobile terminal comprising a NIC, wireless Network Interface Card, used in a wireless LAN, WLAN or the like in an ad hoc network, said card either externally plugged in or built in or integrated in the mobile terminal, wherein the WLAN uses HIPERLAN Type 2 or IEEE 802.11 power save procedures and in which the mobile terminal uses an operating system supporting device power states, e.g. the OnNow device power states (D0-D3), in which method:
the mobile terminal due to inactivity requests (II) a transition from an active state D0 to a less active state D3 (or D2 or D1)
upon which request the NIC and/or mobile terminal requests a further mobile terminal in the ad hoc network to be disassociated and/or de-authenticated from the ad hoc network,
on acknowledgement from the further mobile terminal, the mobile terminal enters a disassociated and/or de-authenticated state.

9. Method according to claim 8 modified in that said request, (II), is replaced by an order.

10. Method according to claim 3 in which the mobile terminal/NIC is disassociated and/or de-authenticated from the ad hoc network without using a disassociation and/or de-authentication signal.

11. Method according to claim 1 in which the mobile terminal/NIC associates and/or authenticates to the access point AP on transition from a less active state D3 (or D2 or D1) to D0.

12. Method according to claim 3 in which the mobile terminal/NIC joins an ad hoc network by associating and/or authenticating to the ad hoc network on transition from a less active state D3 (or D2 or D1) to D0.

13. Method for power saving in a mobile terminal comprising a NIC, wireless Network Interface Card, used in a wireless LAN, WLAN or the like having one access point AP, said card either externally plugged in or built in or integrated in the mobile terminal wherein the WLAN uses HIPERLAN Type 2 or IEEE 802.11 power save procedures and in which the mobile terminal uses an operating system supporting device power states, e.g. the OnNow device power states (D0-D3), in which method:
the mobile terminal forces the NIC down to D3 cold or D3 initialise at a point of time later than a time-out interval due to inactivity in order to lower the system state.

14. Method for power saving according to claim 13, in which the method also comprises the step of the mobile terminal forcing the NIC from D3 cold or D3 initialise to a higher power state, when activity is detected or when data is pending for transmission.

15. Method according to claim 13 in which a timer in the mobile terminal is used to initiate the mobile terminal to power down the NIC.

16. Method according to claim 1 in which the NIC enters its lowest power consumption mode.

17. Method for power control in a mobile terminal comprising a NIC, wireless Network Interface Card, used in a wireless LAN, WLAN or the like having one access point AP, said card either externally plugged in or built in or integrated in the mobile terminal/PC, wherein the WLAN uses HIPERLAN Type 2 or IEEE 802.11 power save procedures and in which die mobile terminal uses an operating system supporting device power states, e.g. the OnNow device power states (D0-D3), in which method:
the mobile terminal being in a low power mode, e.g. D3, D2, or D1, requests transition to active state D0,
upon which request the NIC requests the access point to be entered into WLAN active state, and in which the mobile terminal enters the WAN active state on acknowledgement from the access point.

18. Method for power control in a mobile terminal comprising a NIC, wireless Network Interface Card, said card either externally plugged in or built in or integrated in the mobile terminal, and used in a wireless LAN, WLAN or the like in an ad hoc network, said network comprising at least one further mobile terminal, wherein the WLAN uses HIPERLAN Type 2 or IEEE 802.11 power save procedures and in which the mobile terminal uses an operating system supporting device power states, e.g. the OnNow device power states (D0-D3), in which method:
the mobile terminal being in a low power mode, e.g. D3, D2, or D1, requests transition to active state D0,
upon which request the NIC requests the further mobile terminal to be entered into WLAN active state, and
in which the mobile terminal enters the WLAN active state on acknowledgement from the further terminal.

19. Method according to claim 5 in which the mobile terminal/NIC is disassociated and/or de-authenticated from the AP without using a disassociation and/or de-authentication signal.

20. Method according to claim 8 in which the mobile terminal/NIC is disassociated and/or de-authenticated from the ad hoc network without using a disassociation and/or de-authentication signal.

21. Method according to claim 5 in which the mobile terminal/NIC associates and/or authenticates to the access point AP on transition from a less active state D3 (or D2 or D1) to D0.

22. Method according to claim 8 in which the mobile terminal/NIC joins an ad hoc network by associating and/or authenticating to the ad hoc network on transition from a less active state D3 (or D2 or D1) to D0.

23. Method according to claim 3 in which the NIC enters its lowest power consumption mode.

24. Method according to claim 5 in which the NIC enters its lowest power consumption mode.

25. Method according to claim 8 in which the NIC enters its lowest power consumption mode.
